(19) United States
(12) Patent Application Publication
(10) Pub. No.: US 2007/0178972 A1
(43) Pub. Date: Aug. 2, 2007

(54) Gaming facility and method of operation thereof

(75) Inventor: Martin Paul Moshal, Gibraltar (GI)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waterleaf Limited, Douglas (GB)

(21) Appl. No.: 10/582,143

(22) PCT Filed: Feb. 17, 2005
(86) PCT No.: PCT/IB05/00393

§ 371 Date: Mar. 27, 2007

(30) Foreign Application Priority Data
Feb. 19, 2004 (GB) 0403705.7

(51) Int. Cl. A63F 13/00

(52) U.S. Cl. 463/43

(57) ABSTRACT

A gaming system comprises one or more player stations, a repository containing a number of different software programs, and a download server communicable with the repository and each one of the player stations by means of a communication network. Each player station is identified by a unique code and is operable by a respective player to play a corresponding game. Each software program in the repository is executable on any player station to generate a simulation of a different game. One or more of selected software programs contained in the repository are encrypted, remotely from any of the player Stations, as a function of the unique identification code of a particular of the player stations. The download server is responsive to the encryption and downloads the encrypted software program or programs to the particular player station whose unique identification code was used for encryption. A security module associated with the particular player station decrypts the downloaded encrypted software program or programs to obtain therefrom a decrypted identification code. The security module enables execution of the downloaded encrypted software programs by the particular player station when the decrypted identification code is the same as the unique identification code of the particular player station, and disables execution of the downloaded encrypted software programs by the particular player station when the decrypted identification code is different from the unique identification code of the particular player station. The security module also disables execution of the software programs when the software program have not been encrypted.

### FIELD OF THE INVENTION

This invention relates to a gaming facility and, more particularly, to a gaming facility suitable for providing gaming services to players at a land-based casino. The Invention extends to a method of operation of a gaming facility.

### BACKGROUND TO THE INVENTION

Gaming has rapidly increased in popularity as a leisure activity in the last few years, whether purely for amusement or for wagering purposes.

Gaming for amusement is available primarily by means of game software that is executed on a game console or a computer workstation, or that is executed on a gaming machine of a type that is commonly found in amusement arcades.

There are many streams of gaming activity for wagering purposes, namely traditional casino games, multiplayer games such as poker, blackjack and bingo, and sports betting. Further, most gaming can be conducted in an establishment such as a land-based casino, or in an on-line environment such as, for example, at a virtual casino or at an on-line sports book. Multiplayer games such as poker may also be played at physical establishments, or may be played on-line in virtual poker rooms.

Operators of on-line and land-based casinos have differing operational requirements. For example, land-based operators are subject to space constraints and a prime consideration of such an operator is to provide an optimal mix of machines and table games, together with suitable corresponding wagering limits, in order to maximise the profitability of the land-based establishment. On the other hand, operators of on-line casinos, not being subject to such space constraints, require good analysis facilities to facilitate effective management of a virtual business entity.

The provision and dissemination of new games in a land-based establishment, whether for pure amusement or for wagering purposes, is unnecessarily complex and time-consuming, as it requires physical replacement or re-configuration of gaming machines and tables at which games are played. In an on-line environment, the game mix provided by an on-line casino can be easily altered by software changes only.

### OBJECT OF THE INVENTION

It is an object of this invention to provide a gaming facility that will, at least partially, provide operators of land-based gaming establishments with increased flexibility in operating and managing the land-based gaming establishments relative to known prior art gaming facilities.

### SUMMARY OF THE INVENTION

In accordance with this invention there is provided a processor module for a player station operable by a player to play a game thereon, comprising:
a processor capable of executing a software program to generate a simulation of the game;
a storage memory accessible by the processor;
an interface facility communicable with the processor and with at least one peripheral device;
a unique identification code associated with the processor module; and
a security module co-operable with the processor, the security module being arranged to enable execution of the software program by the processor when the program is encrypted with the unique identification code associated with the processor module, and to disable execution of the software when the software program is encrypted with a code that is different from the unique identification code associated with the processor module.

Further features of the invention provide for the security module to also disable execution of the software program when the software program is unencrypted, for the unique identification code to be stored in a protected area of the storage memory, for the protected area of the storage memory to be a read-only memory, for the interface facility to be an input/output circuit connected to the processor by means of an input/output bus, for the at least one peripheral device to be any one of a display monitor, a magnetic card reader, a banknote validator, an array of pushbuttons, a coin acceptor, a ticket reader, a numeric keypad, a printer and a counter, and for communication between the processor and the at least one peripheral device to be encrypted.

Still further features of the invention provide for the processor module to include a random number generator, for the random number generator to be a hardware random number generator, for the storage memory to include a still further portion that is removable, preferably a flash memory module, for the processor module to include a network interface for providing access to a communication network, preferably the Internet, for the processor module to also include a number of interface ports, and for the number of interface ports to include any one or more of a serial communication port and a port conforming to the Universal Serial Bus standard.

The invention extends to a player station incorporating a processor module as hereinbefore described.

The invention further extends to a method for configuring a processor module for a player station operable by a player to play a game thereon, comprising the steps of:
providing a software program executable to generate a simulation of the game;
obtaining a unique identification code associated with the processor module;
encrypting the software program remotely from the processor module as a function of the unique identification code;
transferring the encrypted software program to the processor module;
decrypting the encrypted software program to obtain a decrypted identification code therefrom; and
enabling execution of the encrypted software program by the processor module when the decrypted identification code is the same as the unique identification code of the processor module and disabling execution of the encrypted software program by the processor module when the decrypted identification code is different from the unique identification code of the processor module.

There is further provided for also disabling execution of the software program by the processor module when the software program is unencrypted, for storing the unique identification code securely in a protected area of a storage memory associated with the processor module, for execution of the encrypted software program to be enabled for a predetermined period of time, and for re-enabling execution of the encrypted software program upon the occurrence of a predetermined event.

There is still further provided for jointly encrypting a plurality of different software programs remotely from the processor module as a function of the unique identification code, each one of the plurality of software programs being executable to produce a simulation of a different game, for transferring the jointly encrypted plurality of software programs to the processor module, for decrypting the jointly encrypted plurality of software programs to obtain a decrypted identification code therefrom, and for enabling execution of any selected one of the jointly encrypted plurality of software programs when the decrypted identification code is the same as the unique identification code of the processor module, and disabling execution of all of the jointly encrypted plurality of software programs when the decrypted identification code is different from the unique identification code of the processor module.

The invention extends still further to a system for the customisation and distribution of software, comprising:
a number of player stations, each player station being operable by a respective player to play a corresponding game, each player station being associated with a unique identification code;
a repository containing a number of different software programs, each software program being executable by at least one of the number of player stations to generate a simulation of a different game;
a download server communicable with the repository;
a communication network enabling communication between the download server and each one of the number of player stations;
encryption means operable to encrypt, remotely from the number of player stations, a selectable one of the number of different software programs contained in the repository as a function of the unique identification code of a selectable one of the number of player stations, the download server being responsive to the encryption means to download the encrypted software program to the particular player station whose unique identification code was used for encryption; and
a security module associated with the particular player station, the security module being capable of decrypting the downloaded encrypted software program to obtain therefrom a decrypted identification code and enabling execution of the downloaded encrypted software program by the particular player station when the decrypted identification code is the same as the unique identification code of the particular player station, and disabling execution of the downloaded encrypted software program by the particular player station when the decrypted identification code is different from the unique identification code of the particular player station.

There is further provided for the security module to also disable execution of the software program by the particular player station when the software program is unencrypted, for the security module to enable execution of the downloaded encrypted software program for a predetermined period of time, and for the security module to re-enable execution of the downloaded encrypted software program upon the occurrence of a predetermined event.

There is still further provided for the encryption means to jointly encrypt, remotely from the number of player stations, a plurality of different software programs as a function of the unique identification code of the selectable one of the number of player stations, each one of the plurality of software programs being executable to produce a simulation of a different game, for the download server being responsive to the encryption means to download the jointly encrypted plurality of software programs to the particular player station whose unique identification code was used for encryption, for the security module to decrypt the jointly encrypted plurality of software programs to obtain a decrypted identification code therefrom and to enable execution of any selected one of the jointly encrypted plurality of software programs by the particular player station when the decrypted identification code is the same as the unique identification code of the particular player station, and disabling execution of all of the jointly encrypted plurality of software programs by the player station when the decrypted identification code is different from the unique identification code of the particular player station.

There is yet further provided for each player station to have an associated storage memory, for the unique identification code of the player station to be stored securely in a protected area of the storage memory, for the protected area of the storage memory to be a read-only memory, for the player station to include a processor and a number of peripheral devices, for the peripheral devices to be any one or more of a display monitor, a magnetic card reader, a banknote validator, an array of pushbuttons, a coin acceptor, a ticket reader, a numeric keypad, a printer and a counter, and for communication between the processor and the at least one peripheral device to be encrypted.

There is also provided for the processor module to include a random number generator, for the random number generator to be a hardware random number generator, for the storage memory to include a still further portion that is removable, preferably a flash memory module, for the communication network to be the Internet, for the processor module to also include a number of interface ports, and for the number of interface ports to include any one or more of a serial communication port and a port conforming to the Universal Serial Bus standard.

The invention extends yet further to a method for the customisation and distribution of software, comprising the steps of:
providing a number of player stations, each player station being operable by a respective player to play a corresponding game, each player station being associated with a unique identification code;
providing a repository containing a number of different software programs, each software program being executable by at least one of the number of player stations to generate a simulation of a different game;
encrypting, remotely from the number of player stations, a selected one of the number of different software programs contained in the repository as a function of the unique identification code of a selected one of the number of player stations;
downloading the encrypted software program to the particular player station whose unique identification code was used for encryption;
decrypting the downloaded encrypted software program to obtain therefrom a decrypted identification code; and enabling execution of the downloaded encrypted software program by the particular player station when the decrypted identification code is the same as the unique identification code of the particular player station, and disabling execution of the downloaded encrypted software program by the particular player station when the decrypted identification code is different from the unique identification code of the particular player station.

There is further provided for also disabling execution of the software program by the particular player station when the software program is unencrypted, for enabling execution of the downloaded encrypted software program for a predetermined period of time, and for re-enabling execution of the downloaded encrypted software program upon the occurrence of a predetermined event.

There is still further provided for jointly encrypting, remotely from the number of player stations, a plurality of different software programs as a function of the unique identification code of the selected one of the number of player stations, each one of the plurality of software programs being executable to produce a simulation of a different game, for downloading the jointly encrypted plurality of software programs to the particular player station whose unique identification code was used for encryption, for decrypting the jointly encrypted plurality of software programs to obtain a decrypted identification code therefrom, and for enabling execution of any selected one of the jointly encrypted plurality of software programs by the particular player station when the decrypted identification code is the same as the unique identification code of the particular player station, and disabling execution of all of the jointly encrypted plurality of software programs by the player station when the decrypted identification code is different from the unique identification code of the particular player station.

There is yet further provided for storing the unique identification code of the player station securely in a protected area of a storage memory associated with the player station.

The invention also extends to a system for the distribution of software, comprising:
a repository containing a number of different executable software programs;
a download server communicable with the repository;
a number of processor modules, each processor module being identified by means of a unique identification code and being operable to execute any one of the number of different software programs contained in the repository;
receiving means for receiving a request for a licence to execute a desired combination of at least one software program contained in the repository on at least one of the number of processor modules, the licence request containing at least one selectable identification code-to-software program mapping;
payment means for receiving a fee for the requested licence;
encryption means responsive to payment of the fee to encrypt the particular software program contained in the at least one selectable mapping as a function of the identification code in the mapping;
a download facility operable to download the encrypted particular software program to the particular processor module whose identification code was used for encryption; and
a security module associated with the particular processor module, the security module being capable of decrypting the downloaded encrypted software program to obtain therefrom a decrypted identification code and enabling execution of the downloaded encrypted software program by the particular processor module when the decrypted identification code is the same as the unique identification code of the particular processor module, and disabling execution of the downloaded encrypted software program by the particular processor module when the decrypted identification code is different from the unique identification code of the particular processor module.

There is also provided for the at least one selectable mapping to be a one-to-one mapping, for the licence request to contain a plurality of different one-to-one mappings, each unique processor module identification code being contained in only one such mapping, for the encryption means to be responsive to payment of the fee to encrypt the particular software program contained in each one of different one-to-one mappings as a function of the identification code in that mapping, and for the download facility to download each encrypted software program to the particular processor module whose identification code was used for encryption.

There is also provided for the at least one selectable mapping to be a many-to-one mapping, for the licence request to contain a number of different many-to-one mappings, each unique processor module identification code being contained in only one such mapping, for the encryption means to be responsive to payment of the fee to encrypt the particular software program contained in each one of the different many-to-one mappings with each one of the plurality of identification codes in that mapping to obtain separate encrypted instances of the same software program, and for the download facility to download each encrypted instance of a software program to the particular processor module whose identification code was used for encryption in that instance.

There is also provided for the security module to also disable execution of the software program when the software program is unencrypted, for each processor module to have an associated storage memory, for the unique identification code of the processor module to be stored securely in a protected area of the storage memory, for the protected area of the storage memory to be a read-only memory, for the processor module to be interfaceable to a number of peripheral devices, for the peripheral devices to be any one or more of a display monitor, a magnetic card reader, a banknote validator, an array of pushbuttons, a coin acceptor, a ticket reader, a numeric keypad, a printer and a counter, and for communication between the processor module and the at least one peripheral device to be encrypted.

There is also provided for the processor module to include a random number generator, for the random number generator to be a hardware random number generator, for the storage memory to include a still further portion that is removable, preferably a flash memory module, for the processor module to include a network interface for providing access to a communication network, preferably the Internet, for the processor module to also include a number of interface ports, and for the number of interface ports to include any one or more of a serial communication port and a port conforming to the Universal Serial Bus standard.

The invention also extends to a method for the distribution of software, comprising the steps of:
providing a repository containing a number of different executable software programs;
providing a number of processor modules, each processor module being operable to execute any one of the number of different software programs contained in the repository, and identifying each processor module by means of a unique identification code;
receiving a request for a licence to execute a desired combination of at least one software program contained in the repository on at least one of the number of processor modules, the licence request containing at least one selectable identification code-to-software program mapping;
receiving a fee for the requested licence;
encrypting, in response to payment of the fee and remotely from the number of processor modules, the particular software program contained in the at least one selectable mapping as a function of the identification code in the mapping;
downloading the encrypted particular software program to the particular processor module whose identification code was used for encryption;
decrypting the downloaded encrypted software program to obtain therefrom a decrypted identification code; and
enabling execution of the downloaded encrypted software program by the particular processor module when the decrypted identification code is the same as the unique identification code of the particular processor module, and disabling execution of the downloaded encrypted software program by the particular processor module when the decrypted identification code is different from the unique identification code of the particular processor module.

There is also provided for the at least one selectable mapping to be a one-to-one mapping, for including in the licence request a plurality of different one-to-one mappings, each unique processor module identification code being contained in only one such mapping, for encrypting, in response to payment of the fee, the particular software program contained in each one of different one-to-one mappings as a function of the identification code in that mapping, and for downloading each encrypted software program to the particular processor module whose identification code was used for encryption.

There is also provided for the at least one selectable mapping to be a many-to-one mapping, for including in the licence request a number of different many-to-one mappings, each unique processor module identification code being contained in only one such mapping, for encrypting, in response to payment of the fee, the particular software program contained in each one of the different many-to-one mappings with each one of the plurality of identification codes in that mapping to obtain separate encrypted instances of the same software program, and for downloading each encrypted instance of a software program to the particular processor module whose identification code was used for encryption in that instance.

There is also provided for disabling execution of the software program when the software program is unencrypted, for storing the unique identification code of the processor module securely in a protected area of a storage memory associated with the processor module, for interfacing the processor module to a number of peripheral devices, for the peripheral devices to be any one or more of a display monitor, a magnetic card reader, a banknote validator, an array of pushbuttons, a coin acceptor, a ticket reader, a numeric keypad, a printer and a counter, and for encrypting communication between the processor module and the at least one peripheral device.

### BRIEF DESCRIPTION OF THE DRAWINGS

One embodiment of the invention is described below, by way of example only, and with reference to the abovementioned drawings, in which:

FIG. 1 is a functional representation of a gaming facility according to the invention;

FIG. 2 is a schematic diagram a kiosk of the gaming facility of FIG. 1; and

FIG. 3 is a functional illustration of various software components of the gaming facility of FIG. 1.

### DETAILED DESCRIPTION OF THE INVENTION

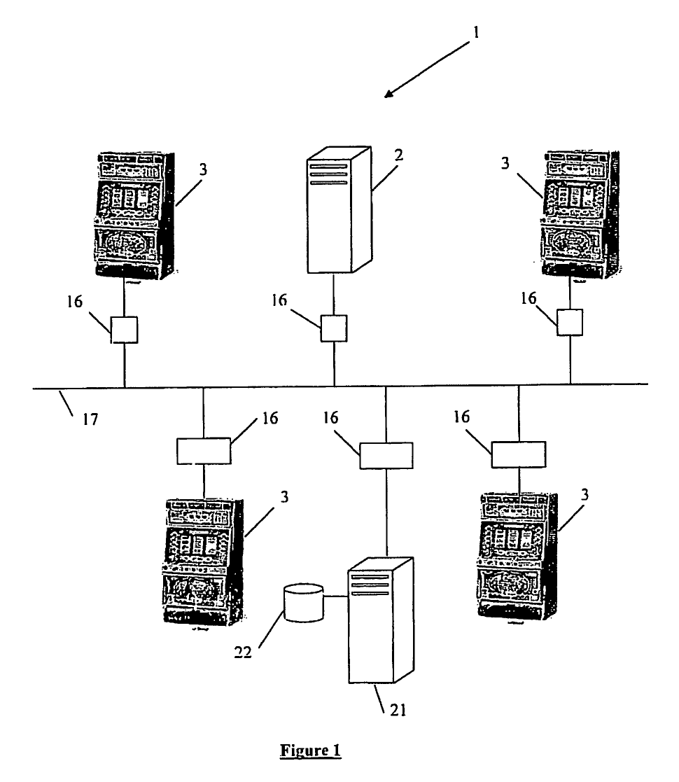

Referring to FIG. 1, a gaming facility is indicated generally by reference numeral (1).

The gaming facility (1) includes a gaming server (2) and a number of player stations (3) in the form of freestanding kiosks located remotely from the gaming server in a land-based establishment such as, for example, a casino or another entertainment venue. In FIG. 1, four such kiosks (3) are indicated.

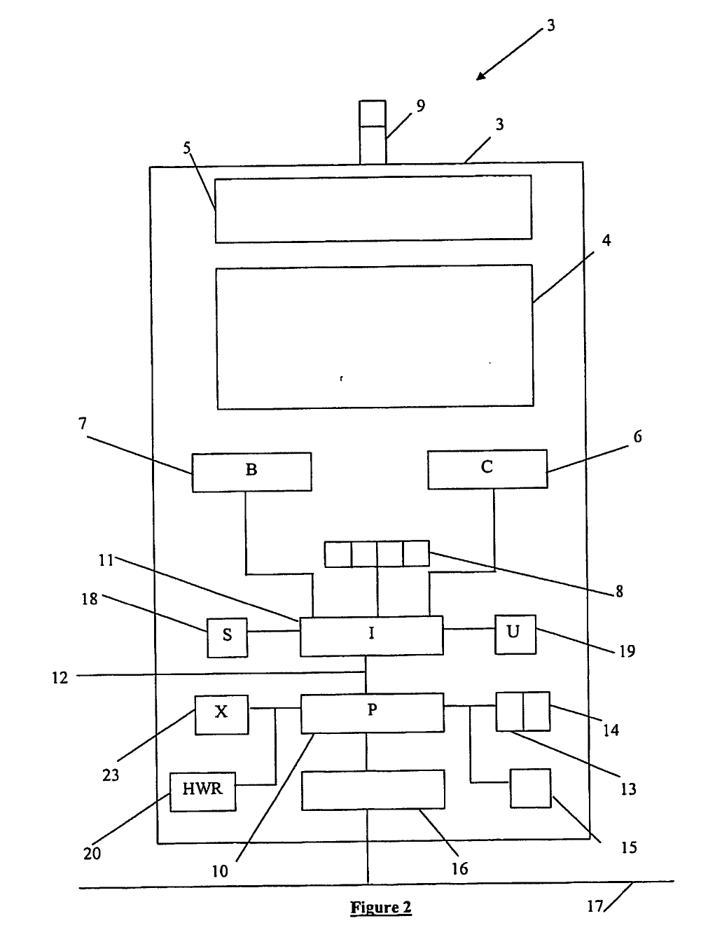

Turning now to FIG. 2, a kiosk (3) is represented in greater detail. Each kiosk (3) has the following peripheral devices: a display means comprising primary (4) and secondary (5) display monitors, a magnetic card reader (6), a banknote validator (7), an array of pushbuttons (8) and a tower light (9). Each kiosk (3) includes a processor module (10), an input/output (“I/O”) interface module (11), an I/O bus (12) connecting the I/O interface module (11) to the processor module (10), and an associated memory that is divided into Random Access Memory (RAM) (13) and Read-Only Memory (14). The kiosk (3) includes, further, a removable memory module (15) of a type that is well known and available under different trade names such as Compact Flash, Smart Media or Multi Media Card memory modules.

A network interface (16) on each kiosk (3) provides for communication between the kiosk and the gaming server (2) by means of a communication network (17). In this embodiment, thin communication network (17) is the Internet. Each kiosk (3) includes, yet further, a serial communication port (18) and an interface port (19) conforming to the well known Universal Serial Bus (“USB”) interface standard that provides communication with any peripheral plug-and-play device that complies with this interface standard.

The processor module (10) includes a hardware random number generator (20), the operation of which will be described in greater detail in the description that follows. The processor module (10) operates under a Windows Embedded XP operating system, which is well known and commercially available from the Microsoft Corporation of Seattle Wash., USA. The gaming server (2) operates under a Windows NT operating system that is also well known and commercially available from the Microsoft Corporation.

The gaming facility (1) includes, still further, a download server (21), as indicated in FIG. (1), that is communicable with the processor module (10) of each kiosk (3) by means of the communication network (17). The download server (21) has an associated repository (22), or data store, containing a software library relating to different games of chance. The function of the download server (21) is to act as a controlled source of gaming software for distribution to the various kiosks (3) of the gaming facility 1, as will be described in detail below. The software distributed to the various kiosks (3) and executed thereon enables players to play the games of chance.

Each processor module (10) in the various kiosks (3) of the gaming facility (1) is identified by means of a unique, embedded, identification code consisting of a 120-bit, or 15-byte, alphanumeric string. A security module (23) is connected to each processor module (10), respectively, as shown in FIG. 2. The unique identification code for a processor module (10) is embedded in a protected area of the ROM (14) of that processor module. Gaming software that is to be executed in a particular kiosk (3) is keyed to that kiosk by encrypting it with the unique identification code of the processor module (10) of that kiosk. In particular, the download server (21) encrypts the gaming software with the unique identification code embedded in the ROM (14) of that particular kiosk (3). Whenever the gaming software is to be executed in the processor module (10), the security module (23) decrypts the encrypted gaming software to recover therefrom the encrypted identification code. If the decrypted identification code does not match the unique identification code embedded in the ROM of the processor module (10), the security module (23) prevents execution of the gaming software, thus rendering the kiosk inoperable. It will be appreciated that, in this manner, gaming software will only successfully execute on a particular processor module (10) for which it has been encrypted, thus preventing gaming software from being copied from one kiosk (3) to a different kiosk, without authorisation, and executing the software.

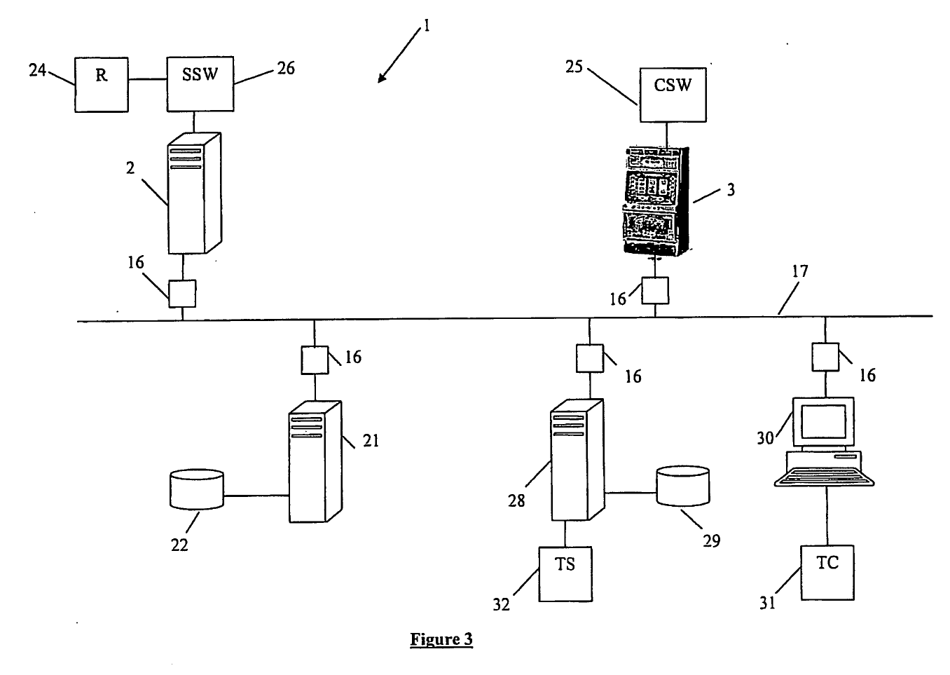

Referring to FIG. 3, the software library contained in the repository (22) contains two classes of games of chance, namely progressive and non-progressive games. In a progressive game, the gaming software consists of two components, a client software program (25) that executes on the processor module (10) of a kiosk (3), and a server software program (26) that executes on a gaming server (2). The gaming server (2) includes a random event generator in the form of a random number generator program (24) that is executable to generate random events upon which an outcome of the progressive game of chance is based. The client software program (25) that executes in the processor module (10) of a kiosk (3) simulates the progress of the progressive game of chance. In each turn of the progressive game, the client software program (25) transmits a request, by means of the communication network (17), to the server software program (26) in the gaming server (2) to cause the random number generator program (24) to generate one or more random events that determine an outcome of the turn of the progressive game. The outcome of the game is transmitted by the server program (26) back to the client software program (25) in the processor module (10) for display by the client software program on the primary display monitor (4).

In a non-progressive game, the client software program (25) operates autonomously without reference to the gaming server (2) for generation of random events. In such a game, the hardware random number generator (20) in the processor module (10) generates the random events necessary to determine an outcome of a turn of the game.

Further, in a progressives game, a predetermined portion of every player wager on an outcome of a turn of the game is contributed to a progressive jackpot prize that can be won by any participating player. It will be appreciated that the same progressive game can be open to participation by players from different land-based establishments and, indeed, also by players who participate on-line. In order to provide a fair progressive game, it is therefore necessary to use a single random number generator for the progressive game, such as the random number generator (24) in the gaming server (2).

This embodiment will be described with particular reference to a non-progressive game of chance in the form of a three-reel video slots game, and a progressive game in the form of a five-reel video slots game. It is to be clearly understood, however, that the choice of these games is merely illustrative and that the scope of the invention is not limited to these particular games of chance. In order to fully understand the operation of the random number generator (20) in a processor module (10) of a kiosk (3), suppose each reel of the three-reel slots game has, say, 30 indexed positions, some or all of which may display a corresponding indicium, and that a turn of the game requires each of the three reels to be spun and to come to rest at any one of the indexed positions. In this instance, the random number generator (20) of processor module (10) that is executing the client software program (25) of the game generates, three random integers between 1 and 30 that correspond to the indexed rest positions of the reels, and that will be displayed to a player on the primary display monitor (4) of the kiosk (3).

An operator of the land-based gaming establishment is required to enable a number of kiosks (3) in the casino or entertainment venue for play by players. The repository (22) associated with the download server (21) contains a different client software program (25) corresponding to each one of a plurality of different games of chance such as, for example, single-player blackjack, poker, slots, roulette and craps. In order to enable the kiosks (3) for play, the operator requests a licence from the download server (21) to use gaming software for the kiosks. The request specifies a unique identification code of each one of the kiosks (3) that are to be enabled, and an identity of a particular game that is to be enabled on each kiosk. As an illustrative example, the operator of the establishment may have, say, 20 kiosks (3) that are to be made available to players for playing games of chance. The operator wishes to arrange his 20 kiosks (3) such that five of them offer a game of three-reel slots for play, a further five of them offer a game of progressive five-reel slots, four others offer poker, three offer single-player blackjack, and roulette is to be available for play on the remaining three kiosks. The request made by the operator to the download server (21) will specify three data items in respect of each kiosk (3), namely: the unique identification code of the kiosk; an identity of a game to be offered for play on the particular kiosk; and a network node address of the kiosk on the communication network (17). In this embodiment, in which the communication network is the Internet, the network node address is an Internet Protocol (“IP”) address, which is well known in the art.

The operator request to the download server (21) for a licence to use the gaming software is placed through a dedicated e-commerce Internet website (not shown), which requires the operator to make payment of a corresponding licence fee for the requested software. Payment of the licence fee can be made by any one of a number of known payment methods that are well known in the art. Once payment of the licence fee has been made by the operator, the download server (21) prepares a client software program (25) corresponding to each specific kiosk (3) by encrypting the requested game software with the unique identification code of that kiosk, as described above. The download server (21) pushes the encrypted client software program (25) to the IP address corresponding to the particular kiosk (3), where the encrypted program is stored in memory (13,14) ready for installation on the processor module (10). In the above example, the download server (21) performs 20 separate encryptions, one for each of the 20 kiosks (3) that the operator wishes to enable for play.

Installation of the encrypted client software program (25) on the processor module (10) of each kiosk (3) is performed automatically under control of the Windows Embedded XP operating system. The installed client software program (25) in then executed subject, of course, to successful decryption by the security module (23), as described above. The client software program (25) of each kiosk (3) causes promotional material to be displayed on the secondary display monitor (5) of that kiosk whenever the program is executing. The promotional material includes a name and a logo of the game of chance and may, optionally, include an animated sequence of images. The promotional display serves as an attract feature to stimulate the interest of would-be players and to draw them to the game.

A player wishing to use the gaming facility (1) is first required to register and to create an account on the gaming server (2). Upon registration, the player is issued with a magnetic card token (not shown) that has a unique player identification number stored thereon and a corresponding player account is established on the gaming server (2). The player is then required to pre-fund the account by purchasing credit that will, for convenience, be denominated in this description in “units” of credit. The gaming server (2) stores a credit balance corresponding to the player's account at all times. The player may purchase credit after completion of the registration formalities or by inserting banknotes at any time into the banknote validator (7) on any one of the kiosks (3), which causes the player's credit balance to be incremented by the gaming server (2), by an amount equal to the number of units purchased by the player.

In order to commence play at a kiosk (3) that offers a desired game, the player inserts his magnetic card token into the magnetic card reader (6) of the kiosk. After insertion of the magnetic card token, the magnetic card reader (6) reads the unique player identification number stored on the token and the processor module (10) transmits the player identification number to the gaming server (2). The gaming server then obtains the player's credit balance and returns It to the kiosk (3) for display to the player on the primary display monitor (4) of the kiosk. The client software program (25) checks whether the player's credit balance is greater than a minimum wager size necessary to play a turn of the particular game of chance available on the kiosk (3). If the players credit balance is smaller than the minimum wager size, a message is displayed to the player on the primary display monitor (4) of the kiosk (3) to fund the account by purchasing credit, which the player can do by introducing one or more banknotes into the banknote validator (7) or, the kiosk. The player's wager is denominated as an integral number of units of credit. The size of the player's wager is displayed on the primary display monitor (4). There must be sufficient credit in the player's account to cover any wager that is made by the player. The kiosk (3) transmits data relating to the size of the wager made by the player across the communication network (17) to the gaming server (2) where it is recorded in a database on an associated storage device (not shown), such as a magnetic or optical storage disk.

The outcome of the turn of the game is determined by the gaming server (2) if the game is a progressive game, and by the processor module (10) of the kiosk (3) where the game is a non progressive game. In the former instance, the gaming server (2) determines the result of the player's wager, that is, whether the wager is successful or unsuccessful, and the magnitude of a prize won if the wager is successful. In the latter instance, the result of the player's wager and the prize won for a successful wager is determined by the processor module (10) in the kiosk (3) and transmitted across the communication network (17) to the gaming server (2). The gaming server (2) then updates the player's stored credit balance as a function of the size of the player's wager and the prize won for a wager that is successful. The updated credit balance of the player is returned to the kiosk (3) where it is displayed to the player on the primary display monitor (4) of the kiosk.

The gaming facility (1) includes a transaction server (28) that is connected to the communication network (17). The transaction server (28) logs transaction data relating to all turns of each game played at any of the kiosks (3), the relevant transaction data being pushed to the transaction server (28) by the gaming server (2). The transaction data includes, for each turn of a game, a minimum of the following parameters:
a code identifying the kiosk (3) on which the turn of the game was played. The code may be the unique identification of the processor module (10) in the kiosk;
an identity of the game of chance that was played by the player at the particular kiosk;
a time and date stamp consisting of a time and a date when the turn of the game was played;
the size of the player's wager in units of credit;
the outcome of the turn of the game;
the result of the player's wager, whether successful or unsuccessful; and
the magnitude of a prize won by the player when the wager is successful.

This transaction data relating to all turns of each game played at any of the kiosks (3) is encrypted and logged in a transaction database (29) on the transaction server (28). It will be appreciated that the transaction database (29) will provide a cumulative log file of data that can be analysed to provide management information that the operator of the gaming facility (1) can use to direct the operation of the facility as a whole, and of each kiosk (3) in particular.

The logged transaction data in the transaction database (29) can be accessed remotely from an enquiry station (30) connected to the communication network (17). Access to the transaction data in the transaction database (29) is provided by means of client and server transaction analysis software programs (31, 32) that execute on the enquiry station (30) and the transaction server (28), respectively. In order to access the encrypted transaction data in the transaction database (29), the operator of the gaming facility is required to first register as a user of the database and to pay a corresponding licence fee, whereupon the operator is provided with a decryption key that will permit the transaction data to be read and analysed in “clear”. Such data encryption and decryption techniques and widely used and are of common knowledge to a person skilled in the field of the invention and for this reason will not be described here in detail.

The client and server transaction analysis software programs (31, 32) analyse the data stored in the transaction database (29) to produce the following standard management reports:
1. gross win for the gaming facility (1) as a whole over any selectable time interval;
2. gross win per individual kiosk (3) over any selectable time interval;
3. gross win per game type, including instances where the game is available for play on more than one kiosk;
4. a profile of total turnover for the gaming facility (1) as a whole, by month, by week, by day and by hour;
5. a profile of total turnover per individual kiosk (3), by month, by week, by day and by hour; and
6. a profile of total turnover per game type, by month, by week, by day and by hour.

The client transaction analysis software program (31) includes a query facility that allows a user to configure any custom management reports that are required by the operator. It will be appreciated that the standard and custom management reports that are produced by analysis of the logged transaction data in this manner can be used by the operator of the gaming facility (1) to optimise the performance of the kiosks (3) in the establishment, and to detect any change in operating conditions.

The licence to use the gaming software on any kiosk (3) may be either perpetual, or may be limited in time. In the latter case, the encrypted client software program (25) on the kiosk (3) includes a facility that will automatically disable the software program from further execution when the term of the licence expires. The operator of the gaming facility (1) is required to renew the licence, which can be done by making payment of a further licence fee, whereupon the encrypted gaming software is enabled for use for a further period of time.

In a variation of the above embodiment, the download server (21) encrypts every game of chance contained in the repository (22) to create a composite encrypted client software program that is pushed to each kiosk (3) in the gaming facility (1) and installed thereon, as described above. In this variation, once the operator of the gaming facility (1) has made payment for the requested licences, the download server (21) transmits to each kiosk (3) an unlocking key for the particular game of chance requested for that kiosk. The unlocking key transmitted to each kiosk (3) enables for play only the desired game for that kiosk (3), leaving the other games in the encrypted client software in a disabled state, thus rendering them unplayable by a player at the kiosk (3).

Alternatively, the composite encrypted client software program (25) may be pushed to each kiosk (3) in the gaming facility (1) as described in the previous paragraph but, in this modification, the unlocking key transmitted to each kiosk (3) permits only one game to be offered for play at that kiosk (3) at any instant.

The operator of the gaming facility (1) is able to select the particular game on offer at any instant at each kiosk (3). The operator of the gaming facility (1) can use the management reports produced by the client and server analysis programs (31, 32), together with visual observation of behaviour of actual and would-be players in the gaming establishment (1), to optimise the performance of the kiosks (3) by altering the mix of games offered by the kiosks (3) of the establishment in real time. For example, the operator may alter the mix of games as a function of the time of day, or the day of the week, increasing the number of kiosks (3) that offer games that are in demand and decreasing the number of kiosks (3) that offer less popular games. As a further example, the operator may also optimise the performance of the gaming facility (1) by altering, in real time, a payout percentage or a pay table, or both, of the game of chance on any kiosk (3) in order to maximise player interest in that game.

Numerous modifications are possible to this embodiment without departing from the scope of the invention. In particular, all communication between the processor module (10) and the interface module (11) of a kiosk (3) and the peripheral devices that relate to monetary value or a value equivalent, such as the banknote validator (7), may be encrypted to enhance the security of the kiosk (3). Further, a kiosk (3) may be configured with additional or different peripheral devices to suit the needs of a particular application, such as coin acceptors, ticket or voucher readers, numeric keypads, coin hoppers, printers and counters. Still further, the secondary display monitor (5) of a kiosk (3) may be dispensed with, and replaced with promotional material silk-screened on a panel to attract would-be players to the game.

Yet further, the gaming facility (1) may be such that none of the available progressive games of chance has a client software program (25) that operates autonomously without reference to the gaming server (2) for generation of random events. In this modification, it is envisaged that the generation of all random events necessary to determine an outcome of any game of chance will be performed by the gaming server (2), thus allowing the hardware random number generator (20) in the processor module (10) of each kiosk (3) to be dispensed with.

The gaming facility (1) may also be operated without a transaction server (28), in which case the transaction data for each turn of a game is logged locally in the same kiosk (3) on which that turn of the game was played. The transaction data is stored in a transaction buffer in the RAM (13) of the kiosk (3). The contents of the transaction buffer (riot shown) are periodically copied to the removable memory module (15) or may, alternatively, be downloaded to a portable data logging device (not shown) that can be connected either to the serial interface port (18) or to the USB interface port (19). As is the case when the transaction server (28) is utilised, the transaction data is encrypted.

In a yet further modification, transfer of encrypted client software programs (25) from the download server (21) to the processor modules (10) of the various kiosks may be performed manually instead of by means of a push from the download server (21) to a processor module (10). It is envisaged that, in terms of this modification, an encrypted client software program (25) may be copied to a removable memory module (15) that can be manually inserted into the processor module (10) of a kiosk (3). Its will be appreciated that, because an encrypted client software program (25) is keyed to a particular processor module (10), the client software program (25) will not execute correctly if the removable memory module (15) is inserted into a processor module (10) of a different kiosk (3).

The transaction data logged in the transaction database (29) of the transaction server (28) exemplified above relates primarily to performance data relating to the performance of each individual kiosk (3) and to the performance of each individual game of chance offered for play on any of the kiosks (3). It will be appreciated that the transaction data, taken in combination with player registration on the gaining server (2) as outlined above, and use of a magnetic card token with a unique player identification number stored thereon, permits individual player game play history to be derived and used in different applications. For example, the individual player game play histories allow the operator of the gaming facility (1) to implement and to manage a comprehensive player loyalty program. The operator is able to obtain, from the client transaction analysis software program (32), a real-time report of cumulative amounts wagered by all players registered on the gaming server (21). On the basis of the amounts wagered by the various players, the operator may elect to award loyalty vouchers to players who have wagered the largest amounts, the vouchers being exchangeable for complimentary services such as, for example, food, beverage and hospitality services. Alternatively, the operator may automate the player loyalty system by interfacing a loyalty administration client workstation (not shown) to the communication network (17) and automatically awarding a loyalty voucher to any player who has wagered a cumulative amount that exceeds a predetermined threshold. In order to fully automate the player loyalty system, each kiosk (3) may be equipped with a printer (not shown). The loyalty administration client workstation causes a loyalty voucher that is awarded to a player to be printed on the printer of the kiosk (3) at which the recipient player is playing. In a further example, a player's game play history may be analysed to derive therefrom player preferences as to choice of game and size of wager. The player preferences are used to construct a personalised and customised portal for the player. The customised portal is displayed to the player on the primary display monitor (4) of a kiosk (3) when the player inserts his magnetic card token into the magnetic card reader (6) on the kiosk (3).

The technical problem solved by this invention is that of achieving mass customisation of software to different licensees thereof and minimisation of the risk of unauthorised use of licensed software by enforcing a one-to-one mapping between executable software and a processor on which the executable software is to run. Logging of gaming data combined with player registration and identification provides a facility that enables an operator of a gaming or entertainment establishment to implement real time control and optimisation of the establishment, as well as the implementation of value-added services to players, such as player loyalty programs, personalised player portals, and drinks management.

The invention therefore provides a customisable gaming facility that exhibits increased functionality and flexibility relative to prior art systems.

1. A processor module for a player station operable by a player to play a game thereon, comprising:
a processor capable of executing a software program to generate a simulation of the game;
a storage memory accessible by the processor;
an interface facility communicable with the processor and with at least one peripheral device;
a unique identification code associated with the processor module; and
a security module co-operable with the processor, the security module being arranged to enable execution of the software program by the processor when the program is encrypted with the unique identification code associated with the processor module, and to disable execution of the software when the software program is encrypted with a code that is different from the unique identification code associated with the processor module.

2. A processor module as claimed in claim 1 in which the security module also disables execution of the software program when the software program is unencrypted.

3. A processor module as claimed in claim 1 in which the unique identification code is stored in a protected area of the storage memory.

4. A processor module as claimed in claim 3 in which the protected area of the storage memory is a read-only memory.

5. A processor module as claimed in claim 1 in which the interface facility is an input/output circuit connected to the processor by means of an input/output bus.

6. A processor module as claimed in claim 1 in which the at least one peripheral device is any one of a display monitor, a magnetic card reader, a banknote validator, an array of pushbuttons, a coin acceptor, a ticket reader, a numeric keypad, a printer and a counter.

7. A processor module as claimed in claim 1 in which communication between the processor and the at least one peripheral device is encrypted.

8. A processor module as claimed in claim 1 in which the processor module includes a random number generator.

9. A processor module as claimed in claim 8 in which the random number generator is a hardware random number generator.

10. A processor module as claimed in claim 9 in which the storage memory includes a still further portion that is removable.

11. A processor module as claimed in claim 10 in which the removable portion of the storage memory is a flash memory module.

12. A processor module as claimed in claim 1 in which the processor includes a network interface that provides access to a communication network.

13. A processor module as claimed in claim 12 in which the communication network is the Internet.

14. A processor module as claimed in claim 1 in which the processor module also includes a number of interface ports.

15. A processor module as claimed in claim 14 in which the number of interface ports include any one or more of a serial communication port and a port conforming to the Universal Serial Bus standard.

16. A method for configuring a processor module for a player station operable by a player to play a game thereon, comprising the steps of:
providing a software program executable to generate a simulation of the game;
obtaining a unique identification code associated with the processor module;
encrypting the software program remotely from the processor module as a function of the unique identification code;
transferring the encrypted software program to the processor module;
decrypting the encrypted software program to obtain a decrypted identification code therefrom; and
enabling execution of the encrypted software program by the processor module when the decrypted identification code is the same as the unique identification code of the processor module and disabling execution of the encrypted software program by the processor module when the decrypted identification code is different from the unique identification code of the processor module.

17. A method as claimed in claim 16 that includes a step of also disabling execution of the software program by the processor module when the software program is unencrypted.

18. A method as claimed in claim 16 in which the unique identification code is stored securely in a protected area of a storage memory associated with the processor module.

19. A method as claimed in claim 16 in which execution of the encrypted software program is enabled for a predetermined period of time.

20. A method as claimed in claim 19 in which execution of the encrypted software program is re-enabled upon the occurrence of a predetermined event.

21. A method as claimed in claim 16 that includes a step of jointly encrypting a plurality of different software programs remotely from the processor module as a function of the unique identification code, each one of the plurality of software programs being executable to produce a simulation of a different game.

22. A method as claimed in claim 21 in which the jointly encrypted plurality of software programs are transferred to the processor module.

23. A method as claimed in claim 22 in which the jointly encrypted plurality of software programs are decrypted to obtain a decrypted identification code therefrom, and execution of any selected one of the jointly encrypted plurality of software- programs is enabled when the decrypted identification code is the same as the unique identification code of the processor module, and execution of all of the jointly encrypted plurality of software programs is disabled when the decrypted identification code is different from the unique identification code of the processor module.

24. A system for customisation and distribution of software, comprising:
a number of player stations, each player station being operable by a respective player to play a corresponding game, each player station being associated with a unique identification code;
a repository containing 3 number of different software programs, each software program being executable by at least one of the number of player stations to generate a simulation of a different game;
a download server communicable with the repository;
a communication network enabling communication between the download server and each one of the number of player stations;
encryption means operable to encrypt, remotely from the number of player stations, a selectable one of the number of different software programs contained in the repository as a function of the unique identification code of a selectable one of the number of player stations, the download server being responsive to the encryption means to download the encrypted software program to the particular player station whose unique identification code was used for encryption; and
a security module associated with the particular player station, the security module being capable of decrypting the downloaded encrypted software program to obtain therefrom a decrypted identification code and enabling execution of the downloaded encrypted software program by the particular player station when the decrypted identification code is the same as the unique identification code of the particular player station, and disabling execution of the downloaded encrypted software program by the particular player station when the decrypted identification code is different from the unique identification code of the particular player station.

25. A system as claimed in claim 24 in which the security module also disables execution of the software program by the particular player station when the software program is unencrypted.

26. A system as claimed in claim 24 in which the security module enables execution of the downloaded encrypted software program for a predetermined period of time.

27. A system as claimed in claim 26 in which the security module re-enables execution of the downloaded encrypted software program upon the occurrence of a predetermined event.

28. A system as claimed in claim 24 in which the encryption means jointly encrypts, remotely from the number of player stations, a plurality of different software programs as a function of the unique identification code of the selectable one of the number of player stations, each one of the plurality of software programs being executable to produce a simulation of a different game.

29. A system as claimed in claim 28 in which the download server is responsive to the encryption means to download the jointly encrypted plurality of software programs to the particular player station whose unique identification code was used for encryption.

30. A system as claimed in claim 29 in which the security module decrypts the jointly encrypted plurality of software programs to obtain a decrypted identification code therefrom and enables execution of any selected one of the jointly encrypted plurality of software programs by the particular player station when the decrypted identification code is the same as the unique identification code of the particular player station and disables execution of all of the jointly encrypted plurality of software programs by the player station when the decrypted identification code is different from the unique identification code of the particular player station.

31. A system as claimed in claim 24 in which each player station has an associated storage memory.

32. A system as claimed in claim 31 in which the unique identification code of the player station is stored securely in a protected area of the storage memory.

33. A system as claimed in claim 32 in which the protected area of the storage memory is a read-only memory.

34. A system as claimed in clam 24 in which each player station includes a processor and a number of peripheral devices.

35. A system as claimed in claim 34 in which the number of peripheral devices include any one or more of a display monitor, a magnetic card reader, a banknote validator, an array of pushbuttons, a coin acceptor, a ticket reader, a numeric keypad, a printer and a counter.

36. A system as claimed in claim 34 in which communication between the processor and the at least one peripheral device is encrypted.

37. A system as claimed in claim 24 in which the processor module includes a random number generator.

38. A system as claimed in claim 37 in which the random number generator is a hardware random number generator.

39. A system as claimed in claim 24 in which the storage memory includes a portion that is removable.

40. A system as claimed in claim 39 removable portion is a flash memory module.

41. A system as claimed in claim 24 in which the communication network is the Internet.

42. A system as claimed in claim 34 in which the processor module also includes a number of interface ports.

43. A system as claimed in claim 42 in which the number of interface ports includes any one or more of a serial communication port and a port conforming to the Universal Serial Bus standard.

44. A method for the customisation and distribution of software, comprising the steps of:
providing a number of player stations, each player station being operable by a respective player to play a corresponding game, each player station being associated with a unique identification code;
providing a repository containing a number of different software programs, each software program being executable by at least one of the number of player stations to generate a simulation of a different game;
encrypting, remotely from the number of player stations, a selected one of the number of different software programs contained in the repository as a function of the unique identification code of a selected one of the number of player stations;
downloading the encrypted software program to the particular player station whose unique identification code was used for encryption;
decrypting the downloaded encrypted software program to obtain therefrom a decrypted identification code; and
enabling execution of the downloaded encrypted software program by the particular player station when the decrypted identification code is the same as the unique identification code of the particular player station, and disabling execution of the downloaded encrypted software program by the particular player station when the decrypted identification code is different from the unique identification code of the particular player station.

45. A method as claimed in claim 44 that includes a step of also disabling execution of the software program by the particular player station when the software program is unencrypted.

46. A method as claimed in claim 44 in which execution of the downloaded encrypted software program is enabled for a predetermined period of time.

47. A method as claimed in claim 46 in which execution of the downloaded encrypted software program is re-enabled upon the occurrence of a predetermined event.

48. A method as claimed in claim 44 in which a plurality of different software programs are jointly encrypted, remotely from the number of player stations, as a function of the unique identification code of the selected one of the number of player stations, each one of the plurality of software programs being executable to produce a simulation of a different game.

49. A method as claimed in claim 48 in which the jointly encrypted plurality of software programs are downloaded to the particular player station whose unique identification code was used for encryption.

50. A method as claimed in claim 49 in which the jointly encrypted plurality of software programs are decrypted to obtain a decrypted identification code therefrom, and execution of any selected one of the jointly encrypted plurality of software programs by the particular player station is enabled when the decrypted identification code is the same as the unique identification code of the particular player station, and execution of all of the jointly encrypted plurality of software programs by the player station is disabled when the decrypted identification code is different from the unique identification code of the particular player station.

51. A method as claimed in claim 44 in which the unique identification code of the player station is stored securely in a protected area of a storage memory associated with the player station.

52. A system for the distribution of software, comprising:
a repository containing a number of different executable software programs;
a download server communicable with the repository;
a number of processor modules, each processor module being identified by means of a unique identification code and being operable to execute any one of the number of different software programs contained in the repository;
receiving means for receiving a request for a licence to execute a desired combination of at least one software program contained in the repository on at least one of the number of processor modules, the licence request containing at least one selectable identification code-to-software program mapping;
payment means for receiving a fee for the requested licence;
encryption means responsive to payment of the fee to encrypt the particular software program contained in the at least one selectable mapping as a function of the identification code in the mapping;
a download facility operable to download the encrypted particular software program to the particular processor module whose identification code was used for encryption; and
a security module associated with the particular processor module, the security module being capable of decrypting the downloaded encrypted software program to obtain therefrom a decrypted identification code and enabling execution of the downloaded encrypted software program by the particular processor module when the decrypted identification code is the same as the unique identification code of the particular processor module, and disabling execution of the downloaded encrypted software program by the particular processor module when the decrypted identification code is different from the unique identification code of the particular processor module.

53. A system as claimed in claim 52 in which the at least one selectable mapping is a one-to-one mapping.

54. A system as claimed in claim 53 in which the licence request contains a plurality of different one-to-one mappings, each unique processor module identification code being contained in only one such mapping.

55. A system as claimed in claim 54 in which the encryption means is responsive to payment of the fee to encrypt the particular software program contained in each one of the plurality of different one-to-one mappings as a function of the identification code in that mapping.

56. A system as claimed in claim 55 in which the download facility downloads each encrypted software program to the particular processor module whose identification code was used for encryption.

57. A system as claimed in claim 52 in which the at least one selectable mapping is a many-to-one mapping.

58. A system as claimed in claim 57 in which the licence request contains a number of different many-to-one mappings, each unique processor module identification code being contained in only one such mapping.

59. A system as claimed in claim 58 in which the encryption means is responsive to payment of the fee to encrypt the particular software program contained in each one of the different many-to-one mappings with each one of the plurality of identification codes in that mapping to obtain separate encrypted instances of the same software program.

60. A system as claimed in claim 59 in which the download facility downloads each encrypted instance of a software program to the particular processor module whose identification code was used for encryption in that instance.

61. A system as claimed in claim 52 in which the security module also disables execution of the software program when the software program is unencrypted.

62. A system as claimed in claim 52 in which each processor module has an associated storage memory.

63. A system as claimed in claim 52 in which the unique identification code of the processor module is stored securely in a protected area of the storage memory.

64. A system as claimed in claim 63 in which the protected area of the storage memory is a read-only memory.

65. A system as claimed in claim 52 in which the processor module is interfaceable to at least one peripheral device.

66. A system as claimed in claim 65 in which the at least one peripheral device is any one or more of a display monitor, a magnetic card reader, a banknote validator, an array of pushbuttons, a coin acceptor, a ticket reader, a numeric keypad, a printer and a counter.

67. A system as claimed in claim 66 in which communication between the processor module and the at least one peripheral device is encrypted.

68. A system as claimed in claim 52 in which the processor module includes a random number generator.

69. A system as claimed in claim 68 in which the random number generator is a hardware random number generator.

70. A system as claimed in claim 64 in which the storage memory includes a portion that is removable.

71. A system as claimed in claim 70 in which the removable portion of the storage memory is a flash memory module.

72. A system as claimed in claim 52 in which the processor module includes a network interface for providing access to a communication network.

73. A system as claimed in claim 72 in which the communication network is the Internet.

74. A system as claimed in claim 52 in which the processor module also includes a number of interface ports.

75. A system as claimed in claim 74 in which the number of interface ports includes any one or more of a serial communication port and a port conforming to the Universal Serial Bus standard.

76. A method for the distribution of software, comprising the steps of:
providing a repository containing a number of different executable software programs,
providing a number of processor modules, each processor module being operable to execute any one of the number of different software programs contained in the repository, and identifying each processor module by means of a unique identification code;
receiving a request for a licence to execute a desired combination of at least one software program contained in the repository on at least one of the number of processor modules, the licence request containing at least one selectable identification code-to-software program mapping;
receiving a fee for the requested licence;
encrypting, in response to payment of the fee and remotely from the number of processor modules, the particular software program contained in the at least one selectable mapping as a function of the identification code in the mapping;
downloading the encrypted particular software program to the particular processor module whose identification code was used for encryption;
decrypting the downloaded encrypted software program to obtain therefrom a decrypted identification code; and
enabling execution of the downloaded encrypted software program by the particular processor module when the decrypted identification code is the same as the unique identification code of the particular processor module, and disabling execution of the downloaded encrypted software program by the particular processor module when the decrypted identification code is different from the unique identification code of the particular processor module.

77. A method as claimed in claim 76 in which the at least one selectable mapping is a one-to-ore mapping.

78. A method as claimed in claim 77 in which the licence request includes a plurality of different one-to-one mappings, each unique processor module identification code being contained in only one such mapping.

79. A method as claimed in claim 77 that includes a step of encrypting, in response to payment of the fee, the particular software program contained in each one of different one-to-one mappings as a function of the identification code in that mapping.

80. A method as claimed in claim 79 in which each encrypted software program is downloaded to the particular processor module whose identification code war, used for encryption.

81. A method as claimed in claim 76 in which at least one selectable mapping is a many-to-one mapping.

82. A method as claimed in claim 81 in which the licence request includes a number of different many-to-one mappings, each unique processor module identification code being contained in only one such mapping.

83. A method as claimed in claim 82 which includes a step of encrypting, in response to payment of the fee, the particular software program contained in each one of the different many-to-one mappings with each one of the plurality of identification codes in that mapping to obtain separate encrypted instances of the same software program.

84. A method as claimed in claim 83 in which each encrypted instance of a software program is downloaded to the particular processor module whose identification code was used for encryption in that instance.

85. A method as claimed in claim 76 in which execution of the software program is disabled when the software program is unencrypted.

86. A method as claimed in claim 76 in which the unique identification code of the processor module is stored securely in a protected area of a storage memory associated with the processor module.

87. A method as claimed in claim 76 that includes a step of interfacing the processor module to at least one peripheral device.

88. A method as claimed in claim 87 in which communication between the processor module and the at least one peripheral device is encrypted.
